(19) United States
(12) Patent Application Publication
(10) Pub. No.: US 2017/0347837 A1
(43) Pub. Date: Dec. 7, 2017

(54) Hot Food Storage Assembly

(71) Applicant: Lydia Stevens, Portsmouth, VA (US)

(72) Inventor: Lydia Stevens, Portsmouth, VA (US)

(21) Appl. No.: 15/172,486

(22) Filed: Jun. 3, 2016

(51) Int. Cl. A47J 41/00; B65D 43/02; B65D 25/28; B65D 81/38; B65D 51/26

(52) U.S. Cl. CPC A47J 41/0061; B65D 81/3837; B65D 51/26; A47J 41/0088; B65D 25/28; B65D 43/02

(57) ABSTRACT

A hot food storage assembly includes a box that may be positioned on a support surface. A cover is removably positioned on the box and the cover has a plurality of openings. A plurality of cans is provided and each of the cans may contain a food item. Each of the cans is comprised of a thermally insulating material. Thus, each of the cans may retain the food item at a pre-determined temperature. Each of the cans is slidably inserted through an associated one of the openings. A plurality of lids is provided and each of the lids is removably coupled to an associated one of the cans. Each of the lids forms a fluid impermeable seal with the associated can. Thus, each of the lids inhibits heat transfer between the food item and air.

### BACKGROUND OF THE DISCLOSURE

### Field of the Disclosure

The disclosure relates to storage devices and more particularly pertains to a new storage device for maintaining a food item at a predetermined temperature.

### SUMMARY OF THE DISCLOSURE

An embodiment of the disclosure meets the needs presented above by generally comprising a box that may be positioned on a support surface. A cover is removably positioned on the box and the cover has a plurality of openings. A plurality of cans is provided and each of the cans may contain a food item. Each of the cans is comprised of a thermally insulating material. Thus, each of the cans may retain the food item at a pre-determined temperature. Each of the cans is slidably inserted through an associated one of the openings. A plurality of lids is provided and each of the lids is removably coupled to an associated one of the cans. Each of the lids forms a fluid impermeable seal with the associated can. Thus, each of the lids inhibits heat transfer between the food item and air.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top perspective view of a hot food storage assembly according to an embodiment of the disclosure.

FIG. 2 is a top exploded view of an embodiment of the disclosure.

FIG. 3 is a cross sectional view taken along line 3-3 of FIG. 1 of an embodiment of the disclosure.

FIG. 4 is a top view of an embodiment of the disclosure.

FIG. 5 is a top perspective view of an alternative embodiment of the disclosure.

### DESCRIPTION OF THE PREFERRED EMBODIMENT

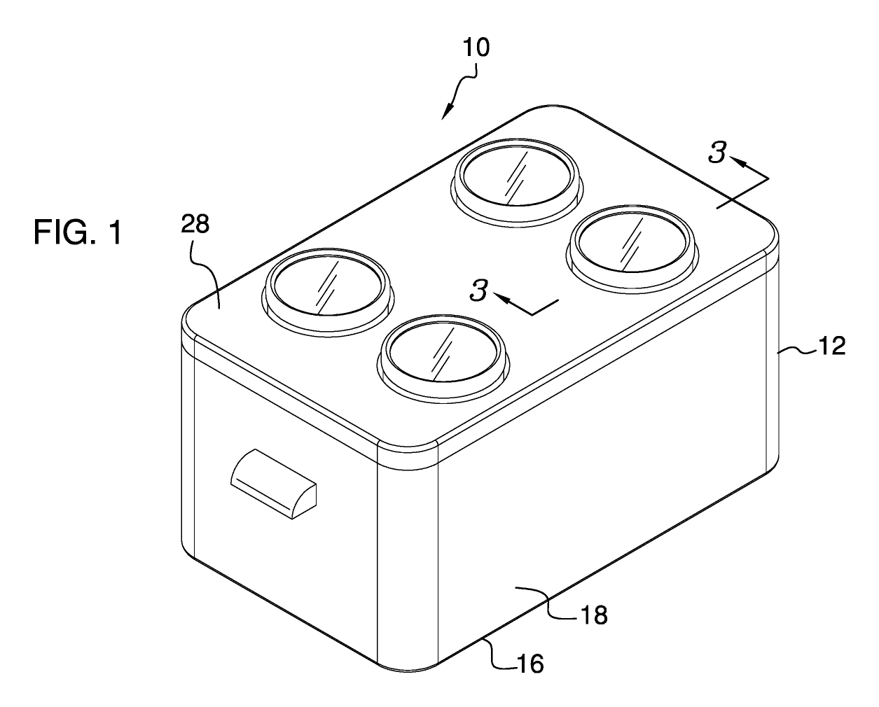

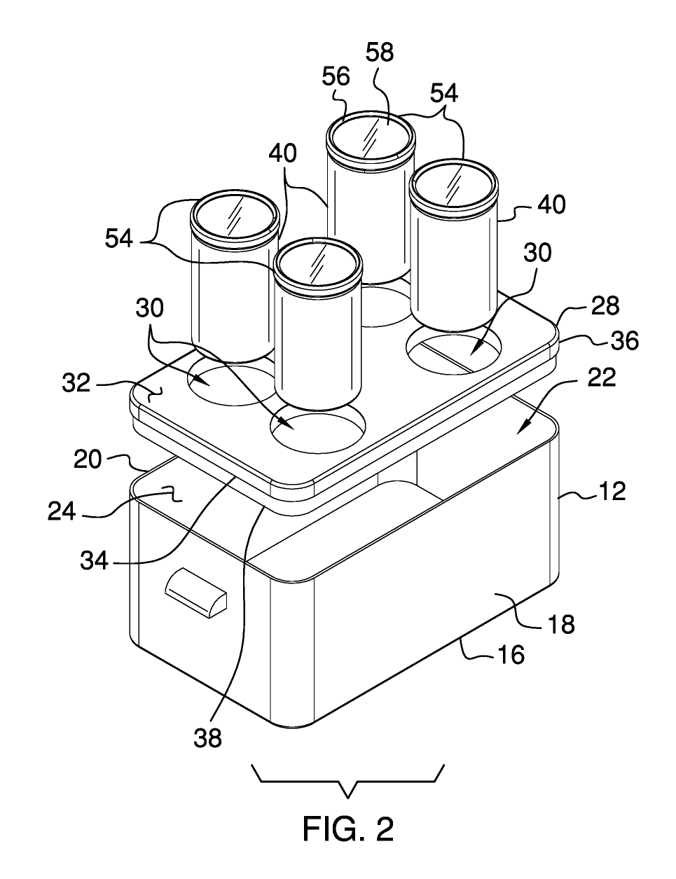

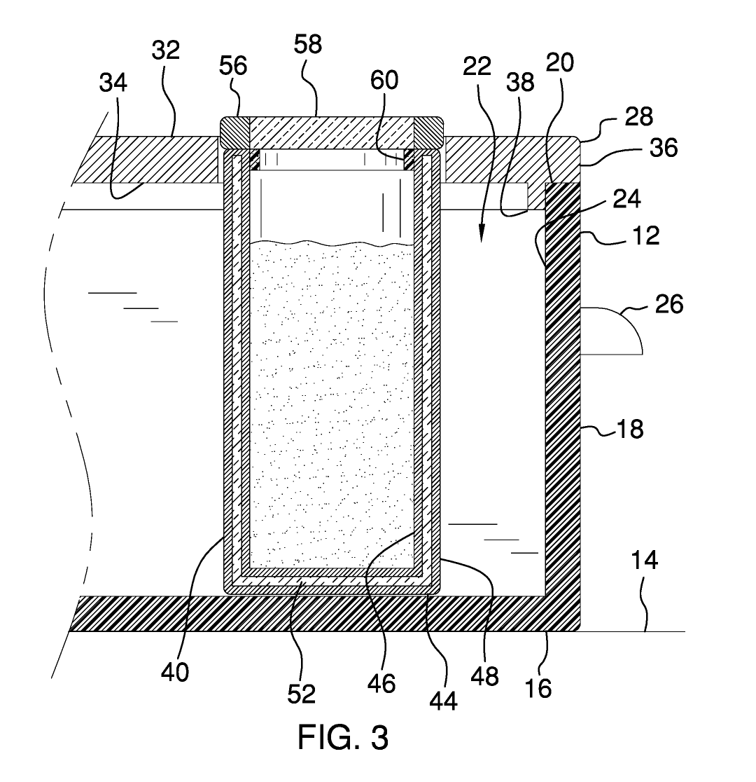

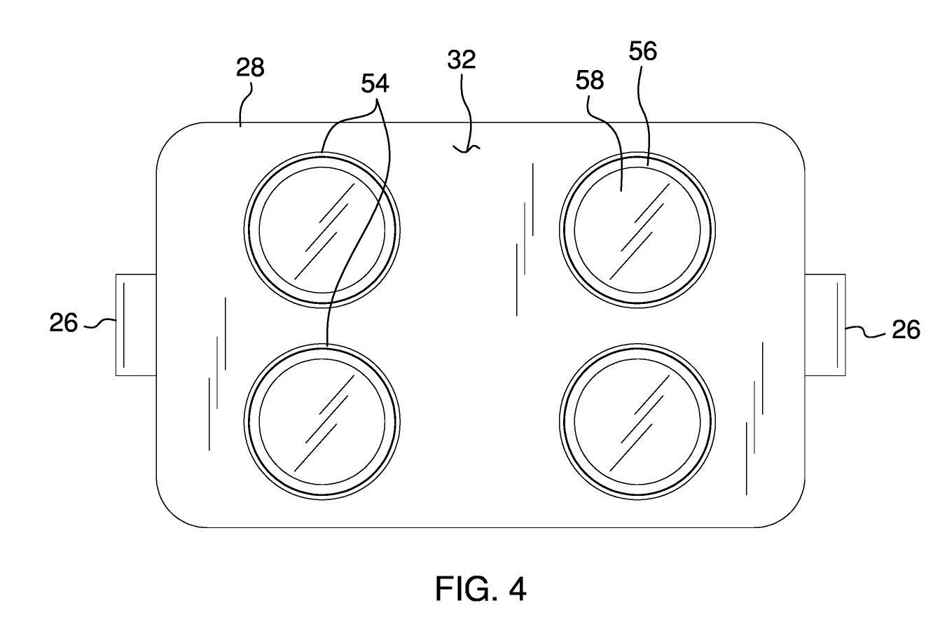

With reference now to the drawings, and in particular to FIGS. 1 through 5 thereof, a new storage device embodying the principles and concepts of an embodiment of the disclosure and generally designated by the reference numeral 10 will be described.

As best illustrated in FIGS. 1 through 5, the hot food storage assembly 10 generally comprises a box 12 that may be positioned on a support surface 14. The support surface 14 may be ground, a table or other horizontal support surface. The box 12 has a bottom wall 16 and a peripheral wall 18 extending upwardly from the bottom wall 16. The peripheral wall 18 has a distal edge 20 with respect to the bottom wall 16. The distal edge 20 defines an opening 22 into the box 12 and the peripheral wall 18 has an inner surface 24. The box 12 may be comprised of a thermally insulating material.

A pair of handles 26 is provided. Each of the handles 26 is coupled to the box 12 and each of the handles 26 may be gripped. Each of the handles 26 may have a curved outer wall to define an inverted cup. Thus, the inverted cup may be gripped to carry the box 12.

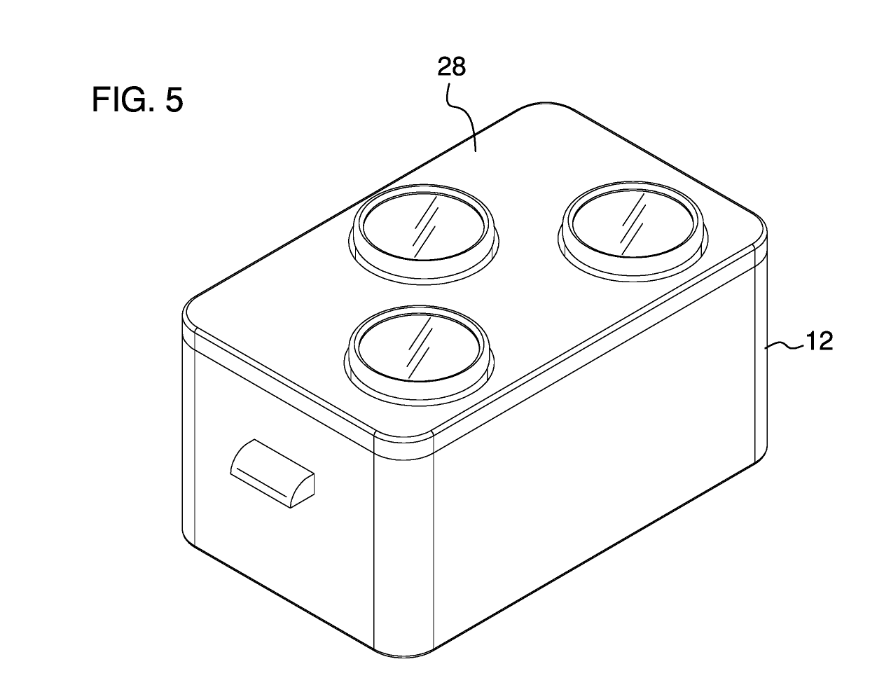

A cover 28 is removably positioned on the box 12 and the cover 28 has a plurality of openings 30. The cover 28 has a top surface 32, a bottom surface 34 and a peripheral edge 36 extending therebetween. The openings 30 extend through the top surface 32 and the bottom surface 34. The openings 30 are spaced apart from each other and are distributed on the cover 28. The openings 30 may be arranged to define four corners of a rectangle. In an alternative embodiment as shown in FIG. 5, the openings 30 may be arranged to form three points of a triangle.

The cover 28 has a lip 38 extending downwardly from the bottom surface 34. The lip 38 is coextensive with the peripheral edge 36 and the lip 38 is spaced inwardly from the peripheral edge 36. The lip 38 frictionally engages the inner surface 24 of the box 12 when the cover 28 is positioned on the distal edge 20. Thus, the lip 38 forms a fluid impermeable seal with the box 12.

A plurality of cans 40 is provided and each of the cans 40 may contain a food item 42. Each of the cans 40 is comprised of a thermally insulating material. Thus, each of the cans 40 may retain the food item 42 at a pre-determined temperature. Each of the cans 40 is slidably inserted through an associated one of the openings 30. Thus, each of the cans 40 is vertically retained in the box 12.

Each of the cans 40 has a lower wall 44, an inside surface 46, an outside surface 48 and a top edge 50. Each of the cans 40 includes an insulating layer 52. The insulating layer 52 is positioned between the inside surface 46 and the outside surface 48. The insulating layer 52 is comprised of a thermally insulating material having a high thermal mass. The lower wall 44 corresponding to each of the cans 40 abuts the bottom wall 16 of the box 12 when the cans 40 are inserted through the associated opening 30.

A plurality of lids 54 is provided. Each of the lids 54 is removably coupled to an associated one of the cans 40. Each of the lids 54 forms a fluid impermeable seal with the associated can 40. Thus, each of the lids 54 inhibits heat transfer between the food item 42 and air.

Each of the lids 54 comprises an outer ring 56 surrounding a plate 58. The plate 58 is comprised of a translucent material. Thus, the plate 58 facilitates the food item 42 to be visible when the cans 40 are positioned in the box 12. A seal 60 is coupled to and extends downwardly from the plate 58 corresponding to each of the lids 54.

The seal 60 is continuous and the seal 60 forms a circle. The seal 60 is centrally positioned on the plate 58. The seal 60 frictionally engages the inside surface 46 of the associated can 40 when the lid 54 is positioned on the top edge 50 of the associated can 40. The seal 60 is comprised of a resiliently compressible material. Thus, the seal 60 forms a fluid impermeable seal with the associated can 40.

In use, the food item 42 is heated and refrigerated to the pre-determined temperature. The food item 42 is placed into each of the cans 40 and the lids 54 are positioned on each of the cans 40. The cans 40 retain the food item 42 at pre-determined temperature. The cover 28 is positioned on the box 12. Each of the cans 40 is slidably positioned in an associated one of the openings 30 in the cover 28. The box 12 is transported to a catering event or the like. Each of the lids 54 is selectively removed from the associated can 40 to access the food item 42. The box 12 and the cans 40 retain the food item 42 at the pre-determined temperature without an extraneous energy source. Thus, the box 12 and cans 42 eliminate a fire hazard or other environmental hazards associated with heating and cooling food items.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A hot food storage assembly configured to maintain food at a pre-determined temperature, said assembly comprising:
a box being configured to be positioned on a support surface;
a cover being removably positioned on said box, said cover having a plurality of openings;
a plurality of cans, each of said cans being configured to contain a food item, each of said cans being comprised of a thermally insulating material wherein each of said cans is configured to retain the food item at a pre-determined temperature, each of said cans being slidably inserted through an associated one of said openings; and
a plurality of lids, each of said lids being removably coupled to an associated one of said cans, each of said lids forming a fluid impermeable seal with said associated can wherein each of said lids is configured to inhibit heat transfer between the food item and air.

2. The assembly according to claim 1, further comprising:
said box having a bottom wall and a peripheral wall extending upwardly from said bottom wall, said peripheral wall having a distal edge with respect to said bottom wall, said distal edge defining an opening into said box, said peripheral wall having an inner surface; and
a pair of handles, each of said handles being coupled to said box wherein each of said handles is configured to be gripped.

3. The assembly according to claim 1, wherein said cover has a top surface, a bottom surface and a peripheral edge extending therebetween, said openings extending through said top surface and said bottom surface, said openings being spaced apart from each other and distributed on said cover.

4. The assembly according to claim 3, wherein:
said box has an inner surface; and
said cover has a lip extending downwardly from said bottom surface, said lip being coextensive with said peripheral edge, said lip being spaced inwardly from said peripheral edge, said lip frictionally engaging said inner surface of said box when said cover is positioned on said distal edge such that said lip forms a fluid impermeable seal with said box.

5. The assembly according to claim 1, wherein:
said box has a bottom wall; and
each of said cans has a lower wall, an inside surface, an outside surface and a top edge, each of said cans including an insulating layer being positioned between said inside surface and said outside surface, said insulating layer being comprised of a thermally insulating material, said lower wall corresponding to each of said cans abutting said bottom wall of said box when said cans are inserted through said associated opening.

6. The assembly according to claim 1, wherein:
each of said cans has an inside surface and a top edge; and
each of said lids comprises an outer ring surrounding a plate, said plate being comprised of a translucent material wherein said plate is configured to facilitate the food item to be visible when said cans are positioned in said box.

7. The assembly according to claim 6, wherein each of said lids includes a seal being coupled to and extending downwardly from said plate, said seal being continuous such that said seal forms a circle, said seal being centrally positioned on said plate such that said seal frictionally engages said inside surface of said associated can when said lid is positioned on said top edge of said associated can, said seal being comprised of a resiliently compressible material wherein said seal is configured to form a fluid impermeable seal with said associated can.

8. A hot food storage assembly configured to maintain food at a pre-determined temperature, said assembly comprising:
a box being configured to be positioned on a support surface, said box having a bottom wall and a peripheral wall extending upwardly from said bottom wall, said peripheral wall having a distal edge with respect to said bottom wall, said distal edge defining an opening into said box, said peripheral wall having an inner surface;
a pair of handles, each of said handles being coupled to said box wherein each of said handles is configured to be gripped;
a cover being removably positioned on said box, said cover having a plurality of openings, said cover having a top surface, a bottom surface and a peripheral edge extending therebetween, said openings extending through said top surface and said bottom surface, said openings being spaced apart from each other and distributed on said cover, said cover having a lip extending downwardly from said bottom surface, said lip being coextensive with said peripheral edge, said lip being spaced inwardly from said peripheral edge, said lip frictionally engaging said inner surface of said box when said cover is positioned on said distal edge such that said lip forms a fluid impermeable seal with said box;
a plurality of cans, each of said cans being configured to contain a food item, each of said cans being comprised of a thermally insulating material wherein each of said cans is configured to retain the food item at a pre-determined temperature, each of said cans being slidably inserted through an associated one of said openings, each of said cans having a lower wall, an inside surface, an outside surface and a top edge, each of said cans including an insulating layer being positioned between said inside surface and said outside surface, said insulating layer being comprised of a thermally insulating material, said lower wall corresponding to each of said cans abutting said bottom wall of said box when said cans are inserted through said associated opening; and
a plurality of lids, each of said lids being removably coupled to an associated one of said cans, each of said lids forming a fluid impermeable seal with said associated can wherein each of said lids is configured to inhibit heat transfer between the food item and air, each of said lids comprising an outer ring surrounding a plate, said plate being comprised of a translucent material wherein said plate is configured to facilitate the food item to be visible when said cans are positioned in said box, each of said lids including a seal being coupled to and extending downwardly from said plate, said seal being continuous such that said seal forms a circle, said seal being centrally positioned on said plate such that said seal frictionally engages said inside surface of said associated can when said lid is positioned on said top edge of said associated can, said seal being comprised of a resiliently compressible material wherein said seal is configured to form a fluid impermeable seal with said associated can.
